(19) United States
(12) Patent Application Publication
(10) Pub. No.: US 2026/0265138 A1
(43) Pub. Date: Sep. 10, 2026

(54) Method and Device for Reinforcing Recycled Aggregate

(71) Applicant: Research Institute of Highway Ministry of Transport, Beijing (CN)

(72) Inventors: Dingding HAN, Beijing (CN); Mingliang LI, Beijing (CN); Hao WU, Beijing (CN); Renfei LI, Beijing (CN); Yingchen CUI, Beijing (CN)

(21) Appl. No.: 19/324,950

(22) Filed: Sep. 10, 2025

(30) Foreign Application Priority Data
Mar. 10, 2025 (CN) 202510272208.7

(51) Int. Cl. C04B 20/10; C04B 18/02; C04B 18/08; C04B 18/167; C04B 103/10; C04B 103/20

(52) U.S. Cl. CPC C04B 20/1003; C04B 18/021; C04B 18/08; C04B 18/167; C04B 20/1077; C04B 2103/10; C04B 2103/20

(57) ABSTRACT

A method and a device for reinforcing a recycled aggregate are provided. The method for reinforcing the recycled aggregate includes: mixing the recycled aggregate with a thin slurry to form a mixture, and subjecting the mixture to impregnation coating to produce a reinforced recycled aggregate, where the impregnation coating is performed under vacuuming and stirring. In the method, both the vacuuming and the stirring are employed during the impregnation coating with the thin slurry.

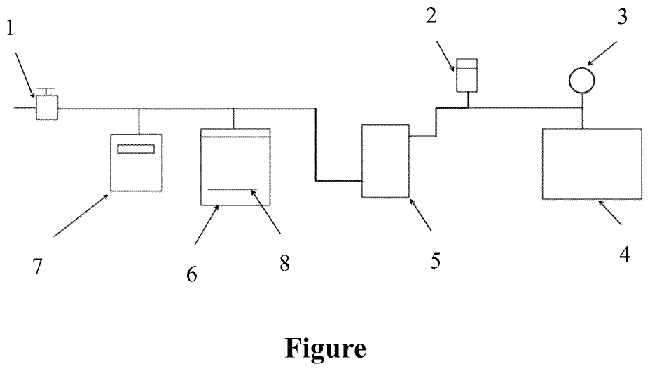

### CROSS REFERENCE TO RELATED APPLICATION

This patent application claims the benefit and priority of Chinese Patent Application No. 202510272208.7 filed with the China National Intellectual Property Administration on Mar. 10, 2025, the disclosure of which is incorporated by reference herein in its entirety as part of the present application.

### TECHNICAL FIELD

The present disclosure belongs to the technical field of recycling construction wastes, and in particular relates to a method and a device for reinforcing a recycled aggregate.

### BACKGROUND

Converting waste concrete into recycled aggregates for use in the preparation of recycled concrete addresses environmental pollution issues while facilitating resource reuse, thereby reducing the consumption of resources and energy. However, compared with natural aggregates, recycled aggregates contain numerous internal micro-cracks, exhibit a higher crushing index value, and possess greater water absorption capabilities. Consequently, the workability, mechanical properties and durability of recycled cement products derived from these recycled aggregates often do not meet engineering requirements. Therefore, enhancing the performance of the recycled aggregates is of significant importance for concrete recycling and sustainable development.

To address the performance deficiencies associated with recycled aggregates, current methods primarily include a slurry-coating method, which involves impregnating recycled aggregates derived from construction waste with a thin slurry formulated from cement and mineral admixtures. Although this method provides good controllability, the limited penetration of the slurry into the recycled aggregates due to osmotic pressure restricts its effectiveness, indicating a need for further improvement. Therefore, enhancing reinforcement effect of the recycled aggregates has become an urgent technical challenge in the field.

### SUMMARY

The present disclosure is intended to provide a method and a device for reinforcing a recycled aggregate. The method provided by the present disclosure results in an excellent reinforcement effect.

In order to achieve the above objects, the present disclosure provides the following technical solutions.

The present disclosure provides a method for reinforcing a recycled aggregate, including:
mixing the recycled aggregate with a thin slurry to form a mixture, and subjecting the mixture to impregnation coating to produce a reinforced recycled aggregate,
where the impregnation coating is performed under vacuuming and stirring.

In some embodiments, the recycled aggregate includes at least one selected from the group consisting of a recycled concrete aggregate and a recycled aggregate derived from red-brick-containing construction waste.

In some embodiments, the thin slurry is made of components including a cement, an accelerator, a fly ash, a retarder and water.

In some embodiments, a mass of the accelerator is 10% to 30% of a total mass of the cement and the accelerator.

In some embodiments, a mass of the retarder is 1% to 5% of the total mass of the cement and the accelerator.

In some embodiments, a vacuum degree of the vacuuming is in a range of 3.4 kPa to 4.0 kPa.

In some embodiments, the stirring is performed at a rotation speed of 5 rpm to 15 rpm.

In some embodiments, the impregnation coating is performed for 30 minutes to 90 minutes.

In some embodiments, the impregnation coating is performed for 60 minutes.

The present disclosure further provides a device for reinforcing the recycled aggregate, including a negative-pressure vessel, and a stirring device provided in the negative-pressure vessel.

The present disclosure provides a method for reinforcing a recycled aggregate, including: mixing the recycled aggregate with a thin slurry to form a mixture, and subjecting the mixture to impregnation coating to produce a reinforced recycled aggregate, where the impregnation coating is performed under vacuuming and stirring. The present disclosure improves a slurry-coating method by employing both the vacuuming and the stirring during the impregnation coating with the thin slurry. The vacuuming enables extracting part of air in internal pores of the recycled aggregate, and the stirring could increase a degree of air extraction from the internal pores of the recycled aggregate, thus maximizing the penetration of the thin slurry into the recycled aggregate, thereby improving reinforcement effect. Experimental results show that after being reinforced by the method provided by the present disclosure, the recycled concrete aggregate has an apparent density of 2,653 kg/m³ to 2,661 kg/m³, a crushing value of 15.84% to 15.92%, and a water absorption of 3.89% to 3.98%; the recycled aggregate from construction waste containing 25% red bricks (volume replacement method) has an apparent density of 2,432 kg/m³, a crushing value of 24.86%, and a water absorption of 8.53%; and the recycled aggregate from construction waste containing 50% red bricks (volume replacement method) has an apparent density of 2,156 kg/m³, a crushing value of 26.86%, and a water absorption of 11.74%.

### BRIEF DESCRIPTION OF THE DRAWINGS

FIGURE shows a device for reinforcing a recycled aggregate provided by an embodiment of the present disclosure, where 1 refers to an inspection port, 2 refers to a pressure regulating device, 3 refers to a vacuum gauge, 4 refers to a vacuum pump, 5 refers to a drying or water accumulation device, 6 refers to a negative-pressure vessel, 7 refers to a pressure gauge, and 8 refers to a stirring device.

### DETAILED DESCRIPTION OF THE EMBODIMENTS

The present disclosure provides a method for reinforcing a recycled aggregate, including:
mixing the recycled aggregate with a thin slurry to form a mixture, and subjecting the mixture to impregnation coating to produce a reinforced recycled aggregate,
where, the impregnation coating is performed under vacuuming and stirring.

In the present disclosure, there are no particular limitations on a source of raw materials, and commercially-available products well known to those skilled in the art may be adopted.

The method provided by the present disclosure is applicable to recycled aggregates, preferably applicable to a recycled concrete aggregate and/or a recycled aggregate derived from red-brick-containing construction waste.

In the present disclosure, a recycled aggregate is mixed with a thin slurry, and a resulting mixture is subjected to impregnation coating to produce a reinforced recycled aggregate.

In some embodiments of the present disclosure, the recycled aggregate includes at least one selected from the group consisting of a recycled concrete aggregate, and a recycled aggregate derived from red-brick-containing construction waste; and the recycled aggregate has a particle size of 10 mm to 30 mm.

In some embodiments of the present disclosure, when the particle size of the recycled aggregate does not meet 10 mm to 30 mm, the recycled aggregate is subjected to crushing. In the present disclosure, there is no special limitation on operation of the crushing, and the operation well known to those skilled in the art may be adopted as long as the particle size of the recycled aggregate could meet the requirements.

As an embodiment of the present disclosure, the recycled aggregate has a particle size of 10 mm to 20 mm, or 20 mm to 30 mm.

In some embodiments of the present disclosure, the thin slurry is made of components including a cement, an accelerator, a fly ash, a retarder and water.

In some embodiments of the present disclosure, a mass of the cement is 70% to 90% of a total mass of the cement and the accelerator.

In some embodiments of the present disclosure, the accelerator is a liquid accelerator; the liquid coagulant is sodium aluminate; and a mass of the accelerator is 10% to 30% of a total mass of the cement and the accelerator. In the present disclosure, the accelerator could improve strength and drying shrinkage resistance of the thin slurry; and limiting the mass of the accelerator to the above ranges enables a maximum improvement in the strength and drying shrinkage resistance of the thin slurry.

As an embodiment of the present disclosure, the mass of the cement is 75% to 85%, or 80% of the total mass of the cement and the accelerator; and the mass of the accelerator is 15% to 25% or 20% to 25% of the total mass of the cement and the accelerator.

In some embodiments of the present disclosure, the fly ash is grade I or a higher quality; a particle size of the fly ash is such that a residue on a 45 μm square mesh sieve is not greater than 12%; and a mass of the fly ash is 10% to 20% of the total mass of the cement and the accelerator. In the present disclosure, the fly ash has excellent filling capacity and pozzolanic reactivity, and thus could significantly improve granular packing of cementitious materials, resulting in improved compactness.

As an embodiment of the present disclosure, a mass of the fly ash is 15% of the total mass of the cement and the accelerator.

In some embodiments of the present disclosure, the retarder is a solid retarder; the solid retarders are lignosulfonates; and a mass of the retarder is 1% to 5%, and preferably 1%, of the total mass of the cement and the accelerator. In the present disclosure, the retarder could ensure sufficient coating and impregnation time of the thin slurry.

In some embodiments of the present disclosure, a water-cement ratio of the thin slurry is 1.0 to 1.2, and preferably 1.0. In the present disclosure, the water-cement ratio determines a thickness of a coating layer. An excessively thick coating layer increases a water absorption of aggregates, while an overly thin coating layer leads to reduced reinforcement effect on the recycled aggregates. Therefore, the water-cement ratio is limited to a range of 1.0 to 1.2.

In some embodiments of the present disclosure, a water-solid ratio of the thin slurry is 5% to 15%, and preferably 10%. In the present disclosure, limiting the water-solid ratio of the thin slurry to the above range could improve the reinforcement effect on the recycled aggregate.

In the present disclosure, there is no special limitation on a ratio of the recycled aggregate to the thin slurry, and any amount that is well known to the skilled in the art may be adopted.

In the present disclosure, there is no special limitation on operation of the mixing the recycled aggregate with the thin slurry, and a technical solution for preparing a mixed material that is well-known to those skilled in the art may be adopted.

In the present disclosure, the impregnation coating is performed under vacuuming and stirring. The present disclosure improves a slurry-coating method by employing both the vacuuming and the stirring during impregnation with the thin slurry. The vacuuming enables extracting part of air in internal pores of the recycled aggregate, and the stirring could increase a degree of air extraction from the internal pores of the recycled aggregate, thus maximizing the penetration of the thin slurry into the recycled aggregate, thereby improving the reinforcement effect.

In some embodiments of the present disclosure, a vacuum degree of the vacuuming is in a range of 3.4 kPa to 4.0 kPa. As an embodiment of the present disclosure, the vacuum degree of the vacuuming is in a range of 3.5 kPa to 3.7 kPa. In the present disclosure, limiting the vacuum degree of the vacuuming to the above range could further improve the reinforcement effect.

In some embodiments of the present disclosure, the stirring is performed at a rotation speed of 5 rpm to 15 rpm. As an embodiment of the present disclosure, the rotation speed of the stirring is 10 rpm. In the present disclosure, limiting the rotation speed of the stirring to the above range could further improve the reinforcement effect.

In some embodiments of the present disclosure, the impregnation coating is performed for 30 minutes to 90 minutes, and preferably 60 minutes; and the impregnation coating is performed at a temperature of not lower than 20° C. In the present disclosure, limiting the duration and temperature of the impregnation coating to the above ranges could further improve the reinforcement effect.

In some embodiments of the present disclosure, after the impregnation coating is complete, the method further includes removing a product obtained by the impregnation coating from the thin slurry, and then drying the product to obtain the reinforced recycled aggregate.

In the present disclosure, there is no special limitation on operation of the removing the product obtained by means of the impregnation coating from the thin slurry, and any method that is well known to the skilled in the art may be used.

In some embodiments of the present disclosure, the drying includes air-drying, curing in a curing room, and oven-drying in sequence.

In some embodiments of the present disclosure, the air-drying is performed indoors; and the air-drying is performed for 20 hours to 30 hours, and preferably 24 hours.

In some embodiments of the present disclosure, the curing in the curing room is performed at a temperature of 19° C. to 21° C., and preferably 20° C.; and the curing in the curing room is performed for 5 days to 10 days, and preferably 7 days.

In some embodiments of the present disclosure, the oven-drying is performed at a temperature of 40° C. to 60° C., and preferably 50° C. In the present disclosure, there is no special limitation on a drying time, provided that the product is dried to a constant weight.

The present disclosure improves the slurry-coating method by employing both the vacuuming and the stirring during the impregnation with the thin slurry. The vacuuming enables extracting part of the air in the internal pores of the recycled aggregate, and the stirring could increase the degree of the air extraction from the internal pores of the recycled aggregate, thus maximizing the penetration of the thin slurry into the recycled aggregate, thereby improving the reinforcement effect.

The present disclosure further provides a device for reinforcing the recycled aggregate, including a negative-pressure vessel, and a stirring device provided in the negative-pressure vessel.

FIGURE shows a device for reinforcing a recycled aggregate provided by an embodiment of the present disclosure, where 1 refers to an inspection port, 2 refers to a pressure regulating device, 3 refers to a vacuum gauge, 4 refers to a vacuum pump, 5 refers to a drying or water accumulation device, 6 refers to a negative-pressure vessel, 7 refers to a pressure gauge, and 8 refers to a stirring device.

As shown in FIGURE, the device for reinforcing the recycled aggregate provided by an embodiment of the present disclosure includes the negative-pressure vessel 6. In the present disclosure, there is no special limitation on dimensions of the negative-pressure vessel, which may be adjusted according to actual needs. In the present disclosure, the negative-pressure vessel is used for the impregnation coating of the recycled aggregate.

As shown in FIGURE, the device for reinforcing the recycled aggregate provided by an embodiment of the present disclosure further includes the stirring device 8 provided in the negative-pressure vessel 6. In the present disclosure, there is no special limitation on a model of the stirring device, and any stirring device that is well known to those skilled in the art may be adopted.

As shown in FIGURE, in an embodiment of the present disclosure, the device for reinforcing the recycled aggregate provided by the present disclosure further includes the vacuum gauge 3. In the present disclosure, there is no special limitation on a position and a model of the vacuum gauge, and any vacuum gauge that is well known to those skilled in the art may be adopted and the position thereof could be determined based on common technical knowledge.

As shown in FIGURE, in an embodiment of the present disclosure, the device for reinforcing the recycled aggregate provided by the present disclosure further includes the vacuum bump 4. In the present disclosure, there is no special limitation on a model and a position of the vacuum bump, and any vacuum bump that is well known to those skilled in the art may be adopted and the position thereof could be determined based on common technical knowledge.

As shown in FIGURE, in an embodiment of the present disclosure, the device for reinforcing the recycled aggregate provided by the present disclosure further includes the pressure regulating device 2. In the present disclosure, there is no special limitation on dimensions of the pressure regulating device, which could be selected according to actual needs.

As shown in FIGURE, in an embodiment of the present disclosure, the device for reinforcing the recycled aggregate provided by the present disclosure further includes the inspection port 1. In the present disclosure, there is no special limitation on a position of the inspection port, and the position thereof could be determined by a person skilled in the art based on common technical knowledge.

As shown in FIGURE, in an embodiment of the present disclosure, the device for reinforcing the recycled aggregate provided by the present disclosure further includes the drying or water accumulation device 5. In the present disclosure, there is no special limitation on dimensions of the drying or water accumulation device, and any device that is well known to those skilled in the art may be adopted. In the present disclosure, the drying or water accumulation device is used to prevent moisture in the negative-pressure vessel 6 from entering the vacuum pump 4.

As shown in FIGURE, in an embodiment of the present disclosure, the device for reinforcing the recycled aggregate provided by the present disclosure further includes the pressure gauge 7. In the present disclosure, there is no special limitation on a model and a position of the pressure gauge, any pressure gauge that is well known to those skilled in the art may be adopted and the position thereof could be determined based on common technical knowledge.

The device for reinforcing provided by the present disclosure is characterized by adding the stirring device to the existing theoretical maximum relative density devices and using the existing detection devices for reinforcing the recycled aggregate, thus realizing application transformation of the device.

The technical solutions of the present disclosure will be clearly and completely described below with reference to the examples of the present disclosure. Apparently, the described examples are merely a part rather than all of the examples of the present disclosure. All other embodiments obtained by those skilled in the art based on the embodiments of the present disclosure without creative efforts should fall within the scope of the present disclosure.

### Example 1

A method for reinforcing a recycled aggregate was performed by the following steps:

(1) A recycled coarse aggregate from waste concrete obtained by crushing construction waste in a crushing station was mixed with a thin slurry to form a mixture. The mixture was subjected to impregnation coating under vacuuming and stirring for 60 minutes, and then removed to produce a coated recycled aggregate, where the recycled coarse aggregate from waste concrete has a particle size of 10 mm to 30 mm; and the impregnation coating was performed at 25° C.

The thin slurry was made of components consisting of #425 cement, an accelerator, a fly ash, a retarder and water. A mass of the cement was 80% of a total mass of the cement and the accelerator. The accelerator was sodium aluminate, and a mass of the accelerator was 20% of the total mass of the cement and the accelerator. The fly ash was grade I and had a particle size satisfying that a residue on a 45 μm square mesh sieve was not greater than 12%, and a mass of the fly ash was 15% of the total mass of the cement and the accelerator. The retarder was a lignosulfonate, and a mass of the retarder was 1% of the total mass of the cement and the accelerator. The thin slurry had a water-cement ratio of 1.0, and a water-solid ratio of 10%. A vacuum degree of the vacuuming was 4.0 kPa; and a rotation speed of the stirring was 10 rpm.

(2) The coated recycled aggregate obtained in step (1) was air-dried in a room for 24 hours, then moved into a 20° C. curing room and cured for 7 days, and then oven-dried at 50° C. to obtain a reinforced recycled aggregate.

### Comparative Example 1

This example was performed on the basis of Example 1 except that the vacuuming and the stirring were omitted, a mixture was turned over every 5 minutes during impregnation coating.

### Comparative Example 2

This example was performed on the basis of Comparative example 1 except that the accelerator and the retarder were omitted.

The reinforced recycled aggregates prepared in Example 1 and Comparative examples 1-2 were subjected to performance tests. Results are shown in Table 1.

TABLE 1
Performance data of reinforced recycled aggregates
prepared in Example 1 and Comparative examples 1-2

| | Compar- | Compar- | | |
|---|---|---|---|---|
| | ative | ative | | |
| | exam- | exam- | | Test |
| No. | ple 2 | ple 1 | Example 1 | criteria |
| Apparent | 2,573 | 2,613 | 2,659 | T0304-2024 |
| density/(kg/m³) | | | | |
| Crushing value/% | 18.26 | 17.42 | 15.84 | T0316-2024 |
| Water absorption/% | 4.95 | 4.63 | 3.91 | T0307-2005 |

As can be seen from Table 1, the method provided by the present disclosure could improve the reinforcement effect on the recycled aggregate.

### Example 2

This example was performed on the basis of Example 1 except that a vacuum degree of vacuuming was 3.4 kPa.

### Comparative Example 3

This example was performed on the basis of Example 1 except that a vacuum degree of vacuuming was 2.8 kPa.

The reinforced recycled aggregates prepared in Examples 1-2 and Comparative example 3 were subjected to performance tests. Results are shown in Table 2.

TABLE 2
Performance data of reinforced recycled aggregates
prepared in Examples 1-2 and Comparative example 3

| | Comparative | | | Test |
|---|---|---|---|---|
| No. | example 3 | Example 2 | Example 1 | criteria |
| Apparent | 2,620 | 2,653 | 2,659 | T0304-2024 |
| density/(kg/m³) | | | | |
| Crushing value/% | 17.26 | 15.92 | 15.84 | T0316-2024 |
| Water absorption/% | 4.59 | 3.98 | 3.91 | T0307-2005 |

As can be seen from Table 2, in the present disclosure, the vacuum degree of the vacuuming has an effect on the reinforcement effect. The crushing value and the water absorption at 3.4 kPa are slightly increased compared to Example 1; and at 2.8 kPa, the crushing value increases by 9.0% and the water absorption increases by 17.4% compared to Example 1. This indicates that as the vacuum degree of the vacuuming decreases, air extraction from the inside of the recycled aggregate is weakened, resulting in a reduced reinforcement effect of the impregnation coating with the thin slurry.

### Example 3

This example was performed on the basis of Example 1 except that a rotation speed of stirring was 15 rpm.

### Comparative Example 4

This example was performed on the basis of Example 3 except that the stirring was omitted, a mixture was turned over every 5 min during impregnation coating process.

The reinforced recycled aggregates prepared in Examples 1 and 3 and Comparative example 4 were subjected to performance tests. Results are shown in Table 3.

TABLE 3
Performance data of reinforced recycled aggregates prepared
in Examples 1 and 3 and Comparative example 4

| | Comparative | | | Test |
|---|---|---|---|---|
| No. | example 4 | Example 3 | Example 1 | criteria |
| Apparent | 2,600 | 2,661 | 2,659 | T0304-2024 |
| density/(kg/m³) | | | | |
| Crushing value/% | 17.58 | 15.88 | 15.84 | T0316-2024 |
| Water absorption/% | 4.61 | 3.89 | 3.91 | T0307-2005 |

As can be seen from Table 3, the rotation speed of the stirring of 15 rpm achieved essentially the same reinforcement effect as the 10 rpm used in Example 1. However, omitting stirring led to a crushing value increased by 10.7% and a water absorption increased by 18.5% compared to Example 3, indicating that stirring facilitates the air extraction from the inside of the recycled aggregate, thereby enhancing the reinforcement effect of the impregnation coating with the thin slurry.

### Example 4

This example was performed on the basis of Example 1 except that the recycled coarse aggregate from waste concrete was replaced with a recycled aggregate derived from construction waste containing 25% red bricks (volume replacement method).

### Comparative Example 5

This example was performed on the basis of Example 4 except that the vacuuming and the stirring were omitted, a mixture was turned over every 5 minutes during impregnation coating.

### Comparative Example 6

This example was performed on the basis of Comparative example 5 except that the accelerator and the retarder were omitted.

The reinforced recycled aggregates prepared in Example 4 and Comparative examples 5-6 were subjected to performance tests. Results are shown in Table 4.

TABLE 4
Performance data of reinforced recycled aggregates
prepared in Example 4 and Comparative examples 5-6

| | Compar- | Compar- | | |
|---|---|---|---|---|
| | ative | ative | | |
| | exam- | exam- | | Test |
| No. | ple 6 | ple 5 | Example 4 | criteria |
| Apparent | 2,353 | 2,384 | 2,432 | T0304-2024 |
| density/(kg/m³) | | | | |
| Crushing value/% | 28.91 | 25.84 | 24.86 | T0316-2024 |
| Water absorption/% | 10.94 | 9.78 | 8.53 | T0307-2005 |

As can be seen from Table 4, the method provided by the present disclosure could improve the reinforcement effect on the recycled aggregate from construction waste containing 25% red bricks.

### Example 5

This example was performed on the basis of Example 1 except that the recycled coarse aggregate from waste concrete was replaced with a recycled aggregate derived from construction waste containing 50% red bricks (volume replacement method).

### Comparative Example 7

This example was performed on the basis of Example 5 except that the vacuuming and the stirring were omitted, a mixture was turned over every 5 minutes during impregnation coating.

### Comparative Example 8

This example was performed on the basis of Comparative example 7 except that the accelerator and the retarder were omitted.

The reinforced recycled aggregates prepared in Example 5 and Comparative examples 7-8 were subjected to performance tests. Results are shown in Table 5.

TABLE 5
Performance data of reinforced recycled aggregates
prepared in Example 5 and Comparative examples 7-8

| | Compar- | Compar- | | |
|---|---|---|---|---|
| | ative | ative | | |
| | exam- | exam- | | Test |
| No. | ple 8 | ple 7 | Example 5 | criteria |
| Apparent | 2,084 | 2,105 | 2,156 | T0304-2024 |
| density/(kg/m³) | | | | |
| Crushing value/% | 30.91 | 28.84 | 26.86 | T0316-2024 |
| Water absorption/% | 15.98 | 12.98 | 11.74 | T0307-2005 |

As can be seen from Table 5, the method provided by the present disclosure could improve the reinforcement effect on the recycled aggregate from construction waste containing 50% red bricks.

As can be seen from the Examples and Comparative examples described above, the reinforcing method provided by the present disclosure has excellent reinforcement effect.

The above descriptions are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

What is claimed is:

1. A method for reinforcing a recycled aggregate, comprising:
mixing the recycled aggregate with a slurry to obtain a mixture, and subjecting the mixture to impregnation coating to obtain a reinforced recycled aggregate,
wherein the impregnation coating is performed under vacuuming and stirring.

2. The method according to claim 1, wherein the recycled aggregate comprises at least one selected from the group consisting of a recycled concrete aggregate, and a recycled aggregate derived from red-brick-containing construction waste.

3. The method according to claim 1, wherein the thin slurry is made of components comprising a cement, an accelerator, a fly ash, a retarder and water.

4. The method according to claim 3, wherein a mass of the accelerator is 10% to 30% of a total mass of the cement and the accelerator.

5. The method according to claim 3, wherein a mass of the retarder is 1% to 5% of a total mass of the cement and the accelerator.

6. The method according to claim 1, wherein a vacuum degree of the vacuuming is in a range of 3.4 kPa to 4.0 kPa.

7. The method according to claim 1, wherein the stirring is performed at a rotation speed of 5 rpm to 15 rpm.

8. The method according to claim 1, wherein the impregnation coating is performed for 30 minutes to 90 minutes.

9. The method according to claim 1, wherein the impregnation coating is performed for 60 minutes.

10. A device for reinforcing a recycled aggregate, comprising a negative-pressure vessel, and a stirring device provided in the negative-pressure vessel.

11. The method according to claim 8, wherein the impregnation coating is performed for 60 minutes.
